(19) United States
(12) Patent Application Publication
(10) Pub. No.: US 2026/0086039 A1
(43) Pub. Date: Mar. 26, 2026

(54) SYSTEM AND METHOD OF GEOMETRICAL INFORMATION ANALYSIS FOR EXPLAINABLE DAMAGE ASSESSMENT

(71) Applicant: Government of the United States as represented by the Secretary of the Air Force, Wright-Patterson AFB, OH (US)

(72) Inventors: Jie Wei, Wappingers Falls, NY (US); Weicong Feng, Staten Island, NY (US); Erika Ardiles-Cruz, New Hartford, NY (US); Erik Blasch, Arlington, VA (US); Paul Schrader, Clinton, NY (US)

(21) Appl. No.: 18/893,244

(22) Filed: Sep. 23, 2024

(51) Int. Cl. G01N 21/88; G01S 17/89; G06T 7/10

(52) U.S. Cl. CPC G01N 21/8851; G01S 17/89; G06T 7/10

(57) ABSTRACT

A method and system for geometrical and topological information analysis for an explainable damage assessment are developed. The system stores pre-disaster and post-disaster point cloud data in computer memory which is connected to a server via a network. The portions of the pre-disaster and post-disaster point cloud data corresponding to the regions of interest are segmented out using geometrical analysis. Features based on topological data analysis techniques for these portions are extracted and stacked as the index reflecting the innate geometrical and topological properties for potential damage assessment. A collection of classifiers are trained to group the damage levels for each region of interest. The damage assessment results identified by the classifiers and a set of explainable items justifying the classification results are reported to a human-readable device.

### GOVERNMENT INTEREST

The invention described herein may be manufactured and used by or for the Government of the United States for all government purposes without the payment of any royalty.

### FIELD OF THE INVENTION

The embodiments herein generally relate to imagery information extraction and analysis, and more particularly to topological data analysis deep learning for imagery systems for damage level assessments.

### BACKGROUND

One cannot overemphasize the importance of situational assessment and awareness (SAA) for Human Assistance and Disaster Response (HADR) and Damage Assessments (DA). During natural disasters in populated regions, proper HADR efforts can be efficiently planned and executed effectively when damage levels are resolved promptly. In such cases, human labeling of images provides a measure of credibility. However, in the presence of large volumes of three-dimensional (3D) imagery, including point cloud data (PCD), there can be significant human assessment time and effort costs.

A continuing, unaddressed need exists for systems and methods to achieve effective SAA response time and efficacy for HADR and DA actions.

### BRIEF SUMMARY OF THE DISCLOSURE

An embodiment herein provides a geometric analysis of a multisource, multidimensional point-cloud data deep learning (GA-PCD-DL) method for damage assessment and situation awareness. A GA-PCD-DL system and method seeks to achieve one or more of numerous objectives. First, data efficiency in the system and method can reduce real-world HADR scenarios' large volumes of data to a compact set of information for reliable damage assessment. Data efficiency can be achieved by transforming the raw data into a feature-based geometric analysis significantly reducing the amount of information content needed to determine damage assessment. Second, computing efficiency can constrain the processing of the system's CPU/RAM/GPU demands to a local device level compute power for HADR personnel, such as a laptop or cellphone. This capability is achieved through analysis of persistent features that characterize damage assessment that decreases the number of processing operations needed to classify a damage level. Third, explainable results can include algorithmic approaches that are repeatable, consistent, and interpretable for practical HADR use. The explainable results can be embodied in a persistent homology (PH) diagram that reflects the innate geometric and topological features of the source data such as clusters, circles, and spheres. Examples of explainable results include the generated classifier statistics and heat-map locations of salient and relevant information. These results are further clarified using such functions as feature importance, model-agnostic explainable AI (XAI) techniques such as Shapley additive explanations (SHAP), or Locally Interpretable Model-Agnostic Explainer (LiME). Fourth, the system and method can be deployable. The system enables data and computing efficiency, affording a lightweight, agile operability on a mobile device such as a laptop or cellphone application for practical use.

In an embodiment, the system can reason why a certain damage level is obtained by providing sufficient evidence and justifications based on (1) physical knowledge of the object such as a digital twin model of the infrastructure, (2) timely and readily available contextual information for HADR personnel, and (3) a configurable assessment based on the destruction situation; to confirm results to HADR personnel before making critical decisions.

In an embodiment, data efficiency can be achieved by utilizing memory to store PCD and a geometrical information extraction module to obtain information about entities and relations to perform damage assessment. The geometrical information extraction system may further comprise an object detection module (i) to obtain regional features corresponding to objects in the scene, and (ii) to input the regional features into explainable results modules consisting of a geometry-driven topological data analysis (TDA) layer [18-20] for damage level assessment ratings.

In an embodiment, computational efficiency processing can be developed through analysis of persistent topological features that characterize DA that decrease the number of processing operations needed to classify a damage level.

In an embodiment, the explainable result module may receive information about the terms, entities, features, and relations, from classifiers coming from conventional machine learning approaches such as a random forest, support vector machine, or deep learning approaches such as convolutional and recurrent neural networks. The explainable result module may receive input from the imagery in the form of PCD features such as normal vectors, Gaussian curvature, and topological properties, which are well-defined in mathematics with solid physical foundations. Output results can be in the form of PH diagrams, feature importance, statistical representation, or general XAI techniques such as LiME and SHAP.

Another embodiment provides a geometrical information extraction system comprising a memory to store imagery and methods to process on a mobile platform such as a laptop or cell phone.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description of the drawings, in which:

FIG. 1 is a representation of the prior art for 3D point cloud image rendering of the terrain with a structure;

FIG. 2 is a block diagram illustrating the components of a system according to an embodiment herein;

FIG. 3 is a block diagram illustrating a segmentation module according to an embodiment herein;

FIG. 4 is a block diagram illustrating a damage assessment module according to an embodiment herein;

FIG. 5 is a flow diagram illustrating aspects of a method for producing explainable results according to an embodiment herein;

FIG. 6 is a representative comparison of the example diagram from the point cloud data from one location at two different times; and

FIG. 7 is a block diagram illustrating an example deployable system, according to an embodiment herein.

### DETAILED DESCRIPTION

Embodiments of the disclosed development, its various features, and the advantageous details thereof, are explained more fully concerning the non-limiting embodiments that are illustrated in the accompanying drawings and detailed in the following description. Descriptions of well-known components and processing techniques are omitted to not unnecessarily obscure what is being disclosed. Examples may be provided, and when so provided are intended merely to facilitate an understanding of how the invention may be practiced and to further enable those of skill in the art to practice its various embodiments. Accordingly, examples should not be construed as limiting the scope of what is disclosed and otherwise claimed.

The systems and methods disclosed relate to challenges for HADR/DA solutions including systems for data and damage assessment levels. The various modules and corresponding components described herein and/or illustrated in the Figures may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein. The various functions can further be embodied and physically saved as any of data structures, data paths, data objects, data object models, object files, and database components. For example, the data objects could include a digital packet of structured data. Example data structures may include any of an array, tuple, map, union, variant, set, graph, tree, node, or object, which may be stored and retrieved by computer memory and may be managed by processors, compilers, and other computer hardware components. The data paths can be part of a computer CPU or GPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. The database components can include any of the tables, indexes, views, stored procedures, and triggers.

Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. The embodiments herein can include both hardware and software elements. The embodiments that are implemented in software include but are not limited to, firmware, resident software, microcode, etc.

The embodiments herein provide a geometrical information analysis for an explainable damage assessment (GIAEDA) system that is based on ground damage level assessment for a specific target domain. Geometrical information analysis refers to extracting and assigning types to the damage level assessments of the objects in the imagery. This capability can play an important role in imagery analytics for surveillance cameras in various target domains. For example, it is relevant in HADR applications such as first response actions, as well as related law enforcement, intelligence, security, and defense applications.

The GIAEDA system disclosed herein can be utilized to aid in Humanitarian Assistance and Disaster Response (HADR) and Situational Assessment and Awareness (SAA). The system and method utilize multi-source 3D PCD data, exploiting the differential geometric and topological properties such as Gaussian curvature, normal vector, and persistence homology to encode pre- and post-disaster data sets. The small number of features and relatively simple classification and clustering algorithms used in the concept result in the benefit of data and computing efficiency. As part of the system and method, building segmentation and damage level assessment are based on physically meaningful features such as Gaussian curvature, normal vectorization, and persistence homology. The data produced by the system and method is transparent and explainable. The data and computing demands incurred by the system and method can be significantly smaller than state-of-the-art methods such as PointNet++, rendering the present system and method relatively more deployable for practical use by HADR personnel.

The typical data modalities used in HADR tasking are overhead imagery taken by satellites or aircraft or land perspectives from ground-based systems, which can reveal the color and texture information of the scene. By contrast, 3D point cloud data carry valuable geometrical information about the scene that can identify the precise location of affected areas, i.e., altitude, latitude, and longitude, thus equipping HADR analysts with more detailed information to assess damages. However, due to the innately heavy information load of 3D point cloud data sensors, such as LiDAR, the generation of 3D PCD with ideal spatial resolution is restricted. As a consequence, the loaded 3D PCD available in HADR scenarios can be generally sparse and noisy, which makes it challenging to single out regions of crucial interest, such as buildings or infrastructures, and further achieve effective damage assessments.

Current human annotation for damage assessment is scaled typically as “no damage”, “minor damage”, “major damage”, and “total damage” which can vary based on the subject-matter expert assessment. To improve the consistency and accuracy of the labeling across buildings or infrastructures, machine or deep learning provides advantages of (1) exhaustive training based on historical content for “no damage” comparisons, (2) ability to discern partial damage analysis across pixels for large infrastructures, (3) tailoring the results based on sub-label classification of damage needs based on the situation (e.g., flooding, wildfires, tornados), and (4) incorporating additional knowledge beyond 3D point cloud data analysis.

Methodology: It is believed that there are several reasons for the lack of prior solutions to the problems presented herein. First, the data are difficult to obtain. There is a general lack of available 3D PCD data in HADR efforts and persistent innate data trouble in HADR applications. Second, there is algorithm difficulty. The DA in HADR involves the one-to-one contrast study of at least two 3D PC data sets, pre- and post-disaster. Unlike the 2D overhead images where there is a precise match of these 2D images where one can invoke contrastive deep learning to learn the effective representations for DA purposes, in 3D PCD such a perfect match does not necessarily exist. More precisely, the 3D data points available in pre-/post-disaster PCD are unlikely to be retained in the post-/pre-disaster PCD and the number of 3D PCD points in pre- and post-disaster sets could vary.

Due to the above challenges in data and damage assessment, the solution of the current disclosure employs geometric and topological data analysis methodologies to achieve accurate and timely labeling of DA classifiers. The solution yields a data and computing efficient, explainable, and deployable DA approach for relevant HADR/DA scenarios

For the GIAEDA system of the present disclosure, three steps are described (1) feature extraction and assessment, (2) 3D segmentation, and (3) damage assessment. The first step includes a pre-disaster (pre-information extraction) component that leverages feature analysis capabilities to extract entities and relations from ground truth damage level assessment, followed by training a geometrical data framework with PCD features as well as derivatives of the extracted information for pre- and post-disaster damage level assessment. The second step is a 3D PCD segmentation process utilizing differential geometry features for building segmentation. The third step includes a post-disaster component, which is a Topological Data Analysis based Damage Assessment.

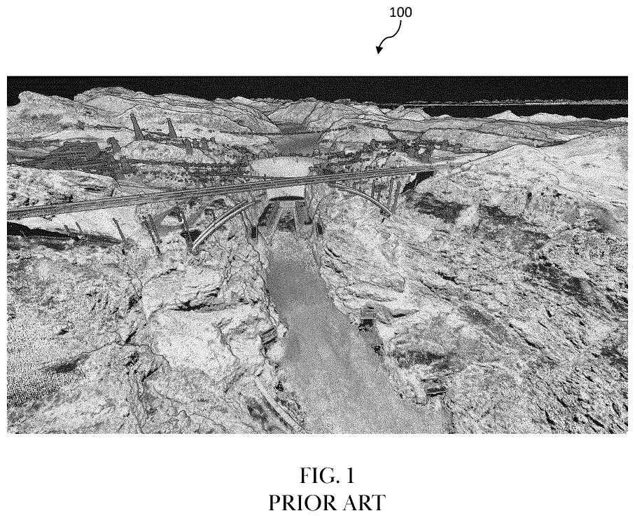

Referring to FIG. 1, there is shown a representative point cloud image 100 of the type useful for the present system and method. The representative point cloud image 100 is an aerial “light detection and ranging” (LiDAR) image of Hoover Dam. Airborne LiDAR (also known as airborne laser scanning) utilizes a laser scanner on an aircraft during flight to create a 3-D point cloud model of a landscape. It is believed that LiDAR is the most detailed and accurate method of creating digital elevation models, replacing photogrammetry. One major advantage in comparison with photogrammetry is the ability of LiDAR technology to filter out reflections from vegetation from the point cloud model to create a digital terrain model that represents ground surfaces such as rivers, paths, buildings, and other structures, which may be concealed by trees. While the image of FIG. 1 is in greyscale, it is understood that color images provide more visual information, both digitally and to a human viewer in human-readable format, including color-indicated elevations or temperature. In the present system and method point cloud images are utilized as digital images.

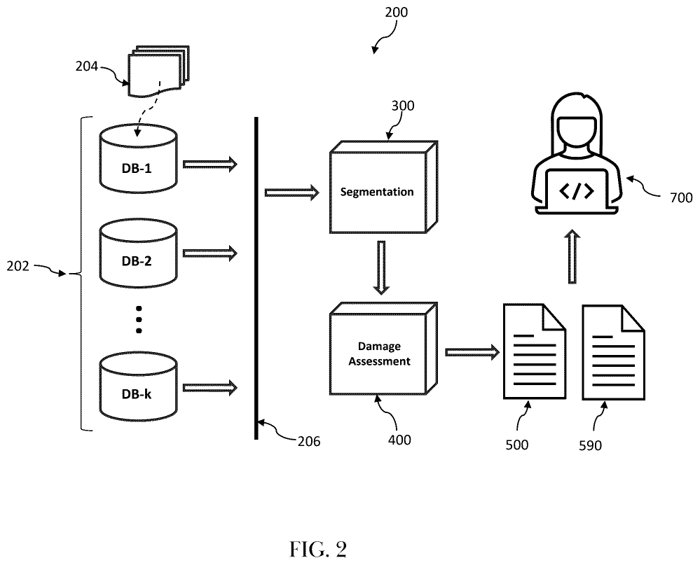

Referring now to FIG. 2, there is shown a block diagram illustrating an example of GIAEDA extraction system 200. A plurality of databases (DB) components 202 labeled DB-1-DB-k (where k is an integer greater than 1), store point cloud images as input 3D PCD imagery 204 data. The collection and storage of 3D PCD imagery is part of the pre-disaster (pre-information extraction) component of the method and system of the disclosure. In an embodiment, pre-disaster and post-disaster point cloud images are stored for the same geographic location. The memory involved in components of System 200 may be Random Access Memory, Read-Only Memory, cache memory, hard drive storage, flash memory, the cloud, or other type of storage mechanisms. Furthermore, the memory of system 200 may be part of a server computer system or electronic device (not shown) that is remotely linked to the GIAEDA system 200 through any wired and wireless communication, according to an example.

The memory content of system 200 can be analyzed via a network communication component 206 of the GIAEDA to output stored images to be analyzed in the GIAEDA geometric segmentation module 300. The network communication component 206 can include any computer hardware and software suitable for the transmission of digital data, including hardware devices, communication buses, memory, interface devices, and wired and wireless connections.

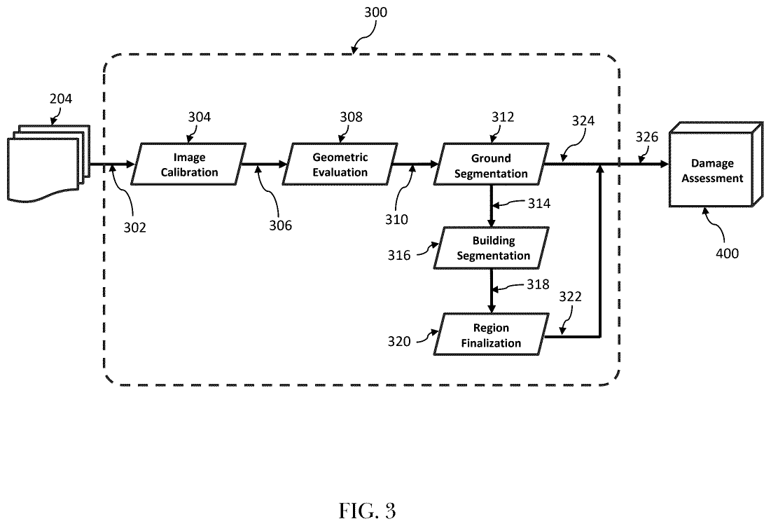

The geometric segmentation module 300, which can include building and structure segmentation, forms part of the 3D PCD segmentation component, and is described in more detail in FIG. 3. The imagery data 204 of geometric segmentation component 300 may be stored as any suitable type of image files such as MPG, MP2, MPEG, MPE, MPV, AVI, WMV, MOV, MKV, VOB, or FLV, among other types of image files and may be presented as image frames. Furthermore, the image data stored in the geometric building segmentation component may comprise pixels, point cloud data, or features. The data from the geometric segmentation module 300 can be utilized for analysis in the damage assessment module 400, as discussed more fully below.

FIG. 3 shows a block diagram illustrating a representative operation of the segmentation module 300. The geometric segmentation module 300 receives point cloud imagery 204 from memory via the network 206 connections from one or more of the plurality of databases 202. The point cloud imagery 204 is digitally transmitted at 302 to an image calibration module 304 which performs data denoising and point set normalization to check if each unit space (a unit space can be an equal divided space, such as one section of a uniform grid) has a similar number of 3D points, a re-sampling/interpolation procedure is invoked if the number of 3D points is too sparse (<75% of the average) or too dense (>125% of the average). The data from the image calibration module 304 is transmitted at 306 to a geometric evaluation module 308. The geometric evaluation module 308 can find the closest neighbors of each point p and evaluates the normal vectors n(p) and Gaussian curvature K to identify buildings, as dictated by Eq. (1), below, by conducting the singular value decomposition (SVD) of the correlation matrix. The data determined at the geometric evaluation model 308 is transmitted at 310 to a ground segmentation module 312. The ground segmentation module 312 segments out points corresponding to the ground. If there are no buildings or structures in imagery 204, the data is transmitted at 324 to exit the segmentation module 300 at 326 for damage assessment at damage assessment module 400. If buildings or structures are present in the point cloud imagery 204, the data is transmitted at 314 to a building segmentation module 316. The building segmentation module 316 collects the non-ground points based on the features g (p) as defined by Eq. (2), below. As an example methodology, geometry-based building segmentation can be completed with PointNet++ [22], a 3D point cloud deep net, over two popular 3D PCD datasets: DALES (Dayton Annotated LiDAR Earth Scan) and IEEE track4 3D PCD data sets. The results from 316 are transferred to 318 to the region finalization 320 as a localization of possible damage areas to be sent at 322 to the damage assessment module 400.

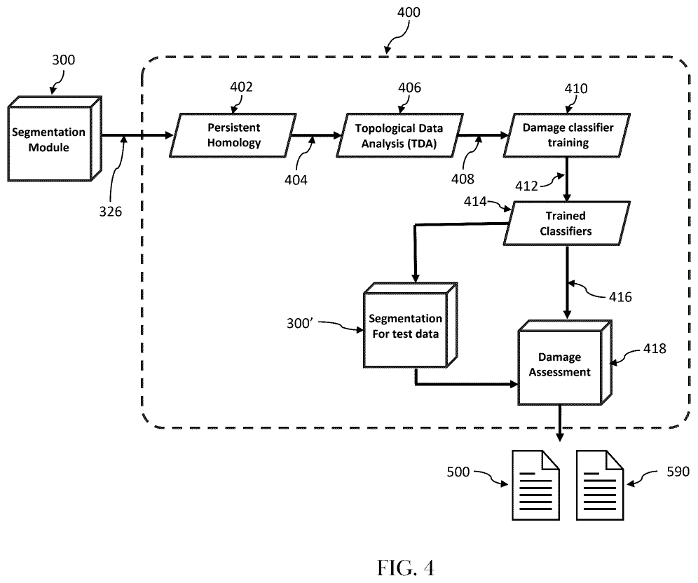

Referring back to FIG. 2, after segmentation analysis of imagery 204, the system and method perform damage assessment at damage assessment module 400 and pass the damage assessment to a results module 500 and/or explainable results module 590. FIG. 4 is a block diagram illustrating an example embodiment of determining a damage assessment at damage assessment module 400, which can then be passed to results module 500 and explainable module 590, as discussed more fully below. The system first evaluates the persistent homology (PH) diagram at the persistent homology module 402 from the segmentation of the training 3D PCD 300, then performs the topological data analysis (TDA) 406 over the PH data structure 404 to create the feature vectors 408 that are passed to the damage classifier training 410. The damage classifier training is then conducted to create trained classifiers 414 transmitted at 412. The damage assessment module 400 can assess damage at 418 and can produce damage level designations for the results module 500. Further, test data 3D PCD segmentation 300′ can be generated by the trained classifier 414, and the explainable components such as PH diagrams, feature importance, SHAP, and LiME items are included in the damage assessment 400 and collected in the explainable results module 590 to help explain the damage levels.

In an example embodiment, differential geometry is employed to extract building features. The following empirical observations in differential geometry are utilized in an example algorithm:
1) Surface Curvature observation: Buildings or any man-made infrastructures are mostly:
   a) developable surfaces or b) part of a sphere (dome). In differential geometry terminology, a developable surface is a smooth surface that can be flattened into a plane without stretching or tearing, and whose Gaussian curvature K is 0. That is,

$$K = {k}_{1} * {k}_{2} \qquad ( 1 )$$

where k₁ and k₂ are the two principal curvatures of a surface. These curvatures are evaluated by taking the maximal and minimal Eigenvalues of the 3D correlation matrix for the given point. In the present methodology, the correlation matrix can be evaluated by taking the 10 closest neighbors in the 3D PCD. Gauss' “Remarkable Theorem,” says that Gaussian curvature can be determined entirely by measuring angles, distances, and their rates on a surface, without reference to the particular manner in which the surface is embedded in the ambient 3-dimensional Euclidean space. Per Gauss' “Remarkable Theorem,” K as evaluated by Eq. (1) is “intrinsic” or determined entirely by local analysis without reference to the embedded geometric space, specifically, a Riemannian space. This methodology results in a relatively stable measure of the surface. Thus, in the case of a) K≈0. In the case of b), K is constant. Therefore, as long as K is 0 or a constant, it can be safely identified as the surface of a building.
2) Surface Normal observation: On the roof/surface of a building, the normal vector n(p) should be close to a constant.

The foregoing two observations entail the following simple 4D representation g(·) for each distinct point p of a given PCD, K(p), and a normal vector, n(p), we have:

$$g ( p ) = [ K ( p ) , n ( p ) ] \qquad ( 2 )$$

Those adjacent PCD points p of constant g (p) per Eq. (2) should thus be clustered as points belonging to a building. With this in hand, a simple DBSCAN clustering procedure is performed to segment out the 3D PCD points of buildings from a pre-disaster 3D PCD raw image data R (i.e., raw data for imagery 204). DBSCAN clustering is a density-based clustering non-parametric algorithm: given a set of points in some space, it groups points that are closely packed (points with many nearby neighbors) and marks as outlying points that lie alone in low-density regions (those whose nearest neighbors are too far away). Then the coordinates of each building in R are used to filter out the corresponding 3D PCD building points in the associated post-disaster PCD raw image data O.

The data from the building segmentation module 316 is transmitted at 318 to a region finalization module 320 that generates the final regions associated with a building by conducting mathematical morphological operators such as opening and closing to merge or discard singular buildings or non-building points to formulate a cluster for a building. At 322 the data from the region finalization module 320 is transmitted to exit the segmentation module 300 at 326 for damage assessment.

Continuing to refer to FIG. 4, at 326 data from the segmentation module 300 is transmitted to the damage assessment module 400. The damage assessment module utilizes persistent homology at the persistent homology module 402. Persistent homology (PH) is a high-fidelity rigorous method for measuring, tracking, and algebraically encoding topological features of a space at different spatial resolutions. More persistent features are detected over a wide range of spatial scales and are deemed more likely to represent true features of the underlying space rather than artifacts of sampling, noise, or particular choice of parameters. the information determined at the damage assessment module 400 can be passed to results module 500 and/or an explainable module 590.

PH methodology is applied to pre- and post-disaster PCD imagery data sets, noted as PH(O) and PH(R), respectively, at persistent homology module 402. At the persistent homology module 402, PH dimensions are computed encoding a multi-set of ordered (birth, death) pairs recording and measuring the lifespan of topological characteristic (e.g., noise and features) for given 3D PCD imagery. Data from the PH module 402 is transmitted at 404 to a topological data analysis (TDA) module 406 that ingests the multi-set data of a given 3D PCD imagery from persistent homology module 402 and computes TDA metrics. The TDA metrics determine precise topological characteristics and behavior of each PH multi-set representation as real-valued scalars, which are then organized into one-dimensional vectors fingerprinting each 3D PCD image. In an embodiment, multiple TDA metrics are computed to include TDA features such as persistence entropy, number of off-diagonal points, and six different metric amplitudes including bottleneck distance (bn), Wasserstein distance (ws), persistence landscape (ls), persistence image (pi), Betti curve (bt), heat maps (hm), and embodiments of numerous representative metrics. At 408 the data from the TDA module 406 is transmitted to a damage classification module 410 and at 412 to an associated trained classifier module 414 which together utilize an AI/ML classifier comprising one many methods such as Random Forest, Extra Tree classifier, Gradient Boosting, LightGBM, and Support Vector Machine. These models are first trained using train 3D PCD and then are used to identify and categorize the fingerprinted 3D PCD images. Categorization can be, for example, in one of four categories for damage assessment annotation: “no damage,” “minor damage,” “major damage,” and “total damage.”

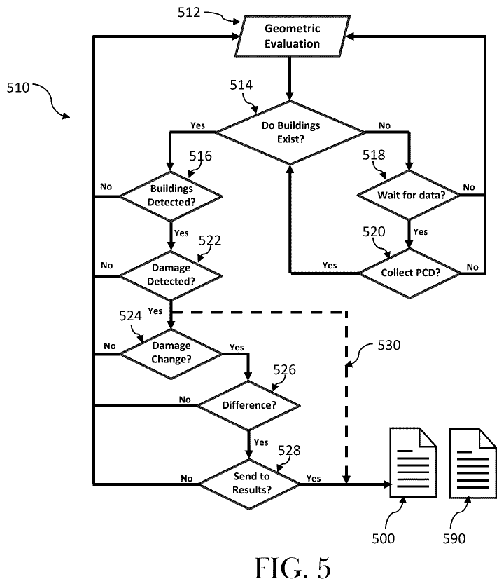

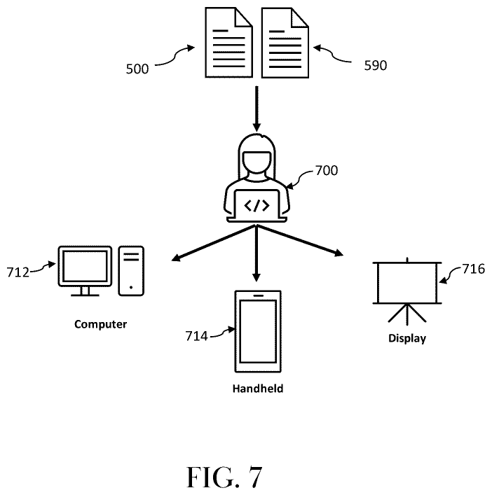

Referring to FIG. 2, module 500 can be, or include, the explainable module 590, for example, as shown in FIG. 5. System 510 includes the reasoning architecture of the system that begins with the geometric evaluation 512. The geometric information is sent to 514 which assesses if buildings and structures exist. If no buildings exist, the system waits for more data 518 and if completed returns for more geometrical evaluation 512; otherwise mode PDC data is collected 520 and analyzed for buildings and structures 514. If buildings exist, three processes are conducted as to whether the buildings are detected 516, the damage is detected 522, and the process of change detection 524. If there is no discernable change detection the information is sent 530 to the results. If there is change detection 524 it is analyzed for the difference of the change 526 and the results sent at 528. For the explainable model 590, the PH diagram, feature importance, SHAP and LIME functions, and embodiments thereof such as heat maps are statistically analyzed for the region of the change detection. Together with the explainable data items in explainable module 590, the results from 528 are sent to the results module 500 to include the damage change detection area, damage levels, and the explainable information to be rendered together on a display 700, as depicted in FIG. 7.

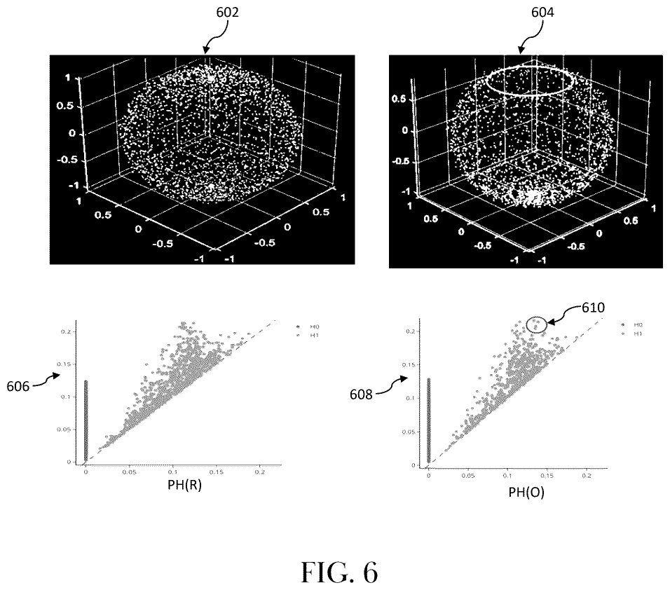

Feature analysis for categorization can be conducted for effective topological data analysis (TDA) for damage assessment in the damage assessment module 400. After identifying one or more buildings, feature analysis can effectively analyze digitally encoded global properties of a point cloud by counting the birth and death of holes in different dimensions. As depicted in an example shown in FIG. 6, a first point cloud 602 corresponds to a perfect sphere. The 3D PCD of first point cloud 602 can have a corresponding PH diagram, represented at 606 and denoted “PH(R).” Similarly, a second point cloud 604 corresponds to a perfect sphere with the top 20% removed, and its PH diagram is depicted at 608 and denoted “PH(O).” As indicated in PH(O), the removal of the top parts of the sphere induced new holes, thus creating new points 610 (circled in FIG. 6) in its corresponding PH diagram. The PH diagrams as illustrated in FIG. 6 constitute the foundation for TDA-based global information encoding as called upon by Eq. (1).

The TDA-based DA classification methodology is based on the following rationale: after damage of a certain level for pre-disaster imagery in PCD R (represented by the sphere of image 602 of FIG. 6), the associated post-disaster imagery PCD O (represented by the partial sphere of image 604 of FIG. 6) will potentially exhibit significant topological changes expressed as new holes or voids in the 3D PCD imagery, thus giving rise to observable variations in the corresponding persistent homology (PH) diagrams. In effect, building or structure damage can induce more points in a PH diagram. The two PH diagrams illustrated in FIG. 6 can be viewed as two corresponding PH diagrams, PH(R) and PH(O): the top part of R was removed by the disaster, resulting in the PH(O). The new points 610 in PH(O) can be harnessed to decide on the damage levels.

It can be unwieldy to employ PH diagrams for classification purposes. TDA provides many different stable metrics to concisely encode the behavioral properties of each PH diagram. For example, persistence entropy (pe), which is the sum of the normalized distance between death and birth values for each type or absence of a hole, denoted as H0, H1, etc., can be harnessed. The number of off-diagonal points (nd) and a collection of other metric amplitudes for each PH can be utilized. In general, no one metric is better than the others and can be scenario-dependent. To retain a diversity of different indexes, for each PH(R) and PH(O) a high dimensional feature vector can be formulated corresponding to multiple PH metrics. For instance, the persistence entropy, number of off-diagonal points, and six different metric amplitudes including bottleneck distance (bn), Wasserstein distance (ws), persistence landscape (ls), persistence image (pi), Betti curve (bt), and heat maps (hm). Each metric has three dimensions:

$$v ( R ) = [ pe , nd , bn , ws , ls , pi , bt , hm ] \qquad ( 3 )$$

As a result of Eq. (3), for each matching pair of PH(R) and PH(O), there is a 48-dimensional numerical vector v encoding the topological behavior before and after changes to buildings or structures, for example, by a disaster event. The original instance of each pre- and post-action 3D PCD is now encoded compactly as a representation into a 48D numerical vector v where each v can be used as a sample to train the AI/ML classifiers for DA purposes.

Referring now to FIG. 5, there is shown a block diagram illustrating an embodiment of a GIAEDA system 510 for producing explainable results for the results module 500, as depicted in FIG. 2. The results module 500 interfaces with the raw 3D PCD data of system 200 as depicted in FIG. 2 by receiving data processed by the segmentation module 300 and the damage assessment model 400. As depicted in FIG. 5, other steps, including optional steps, can be employed in a system indicated as system 510.

Starting at block 512 with the output from the geometric evaluation 308 of the segmentation module 300, the system can query if buildings exist in any of the PCD imagery. The question of the existence of buildings can be considered about what should be present as well as what is detected. If no buildings are known to exist, and no buildings are detected, the system moves to inquiry 518 and waits for data. If not, the system loops back to the geometric evaluation block 512 for additional imagery to be processed. If yes, additional PCD data is collected at 520 and the question of building existence is revisited at 514, or the system loops back to the geometric evaluation block 512 for additional imagery to be processed.

If buildings exist, at 516 the inquiry is if buildings are detected. If not, the system loops back to the geometric evaluation block 512 for additional imagery to be processed. If yes, at 522 the system queries if damage is detected by utilizing pre- and post-disaster imagery. If no at 522, the system loops back to the geometric evaluation block 512 for additional imagery to be processed.

If the answer to the inquiry of damage detected at 522 is yes, the system can optionally take two paths. As indicated at 530, in an embodiment the imagery and information relating to the damage detected can be sent directly to the results module 500. Alternatively, an additional inquiry can be made at 524: is there a change in the damage detected? If not, the system loops back to the geometric evaluation block 512 for additional imagery to be processed. But if yes at 522, at 526 a difference module qualifies and/or quantifies the differences. At 528, the difference information can be looped back to the geometric evaluation block 512 for additional imagery to be processed or it can be sent to the results module 500.

In an embodiment, to achieve DA in HADR 3D PCD data, two steps are needed:
1) First, the system must identify regions of interest where the damages will be assessed; in an example HADR these are the buildings. From the data source, objects are segmented out as the subset of 3D PCD data points corresponding to “buildings” using the output of building segmentation module 316 as depicted in FIG. 3. These should be conducted in the pre-disaster 3D PCD due to the unpredictable impacts of the disasters. Once the regions corresponding to the buildings are identified from the pre-disaster PCD, the 3D coordinates are then used as a filter to locate the corresponding PCD points in the post-disaster PCD data set.
2) For each matching pre- and post-disaster 3D PCD data set R and O resolved by the preceding step, formulate a data vector to reflect possible damages exhibited in the pre- and post-disaster 3D PCD data sets. Recall that there may not be precise point matches between every 3D point in these two sets. That is, a 3D point Rᵢ in R may not have a corresponding matching 3D point Oⱼ in O. So it is not necessary to attempt to identify such matches based on certain error metrics. This also implies that the number of data points in these two sets, denoted by |R| and |O|, could be drastically different (i.e., |R|≠|O|). Alternatively, the innate information of R and O should be embedded in a possibly high-dimensional vector representation v(·) based on R and O as a whole. From this linear information, one can derive analytics to support a DA decision from v(R) and r(O) alone. In our work, the information encoding method v(·) is based on a Topological Data Analysis (TDA) procedure performed in module 300, where the topological properties of R and O, such as holes in varying dimensions, are effectively encoded as a representation of R and O globally. Then an artificial intelligence/machine learning (AI/ML) classification procedure denoted cl is invoked producing discrete damage levels L known as “no damage”, “minor damage”, “major damage”, and “total damage”. That is,

$$L ( R , O ) = cl ( v ( R ) , v ( O ) ) \qquad ( 4 )$$

Combining Eqs. (1)-(4), a distinct DA classification algorithm results. As an instantiation of the method, several mainstream machine learning classification procedures, such as Support Vector Machine, Random Forest, LightGBM, and Extra Tree classier, can be used as a choice for cl in Eq. (4); although other classification learning techniques can be replaced for the machine learning methods. For a simulated dataset with 600 spheres, torus, and cubic with varying “damages”, a simple SVM classifier produced an F1 score of 0.89 for the four different damage levels: no, minor, major, and total damages. By contrast, over the same simulation train/test datasets, other deep learning methods performed rather poorly, falling far behind the TDA-based approach: the closest performance was achieved by contrastive learning with an F1 score of 0.61, and other CNN based Deep Learning methods have F1 scores in the 0.30-0.40 range.

Referring back to FIG. 2, after the results module 500, the information is passed to a device module from which a user can exercise analysis and/or action. FIG. 7 is a diagram illustrating a GIAEDA deployable system 700 which ingests output from results module 500 and can be accessed by a user on one or more of a computer 712, handheld device 714, or another kind of display 716. The explainable demonstrations such as the PH diagram, feature importance, SHAP, and LiME heatmaps in explainable module 590 can be displayed to showcase the reasoning behind the system.

In some examples, the memory of 510 or 520 may be Random Access Memory, Read-Only Memory, cache memory, hard drive storage, flash memory, the cloud, or other type of storage mechanisms. Furthermore, the memory may be part of a server computer system or electronic device (not shown) that is remotely linked to the imagery information extraction system 100 through any wired and wireless communication, according to an example. The imagery in 510, 520, 530, and 540 may be stored as any suitable type of imagery files such as MPG, MP2, MPEG, MPE, MPV, AVI, WMV, MOV, MKV, VOB, or FLV, among other types of imagery files and may be presented as imagery frames. Furthermore, the imagery in 510, 520, and 530 may contain embedded images, text, or other graphics.

The embodiments herein extend the concept of information extraction to imagery by providing a geometry and topology-based imagery information extraction system that is based on ground truth captions generated by humans for a specific target domain. This capability can play an important role in imagery analytics for surveillance cameras in various target domains. For example, it is relevant in HADR applications such as first responders, as well as related law enforcement, intelligence, security, and defense applications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Those skilled in the art will recognize that the embodiments herein can be practiced with modification within the spirit and scope of the appended claims.

What is claimed is:

1. A system for geometrical information analysis for an explainable damage assessment, comprising,
a database in computer memory;
a plurality of point cloud imagery data stored in the database;
a network communication component for transmitting the plurality of point cloud imagery data;
a segmentation module configured to receive at least a portion of the plurality of point cloud imagery data;
a damage assessment module configured to receive information from the segmentation module; and
a results module configured to receive information from the damage assessment module to produce explainable results on a human-readable device.

2. The system of claim 1, wherein the plurality of point cloud imagery comprises LiDAR images.

3. The system of claim 1, wherein the plurality of point cloud imagery comprises point cloud images of a geographic location at two different times.

4. The system of claim 3, wherein the geographic location includes building structures.

5. The system of claim 4, wherein the segmentation module identifies the building structures.

6. The system of claim 1, wherein the damage assessment module uses topological data analysis.

7. The system of claim 1, wherein the damage assessment module can produce damage level designations for the results module.

8. The system of claim 1, wherein the damage assessment module uses persistent homology to encode topological features of pre-disaster and post-disaster of the plurality of point cloud imagery data.

9. The system of claim 1, wherein a human-readable device is a handheld device.

10. A system for geometrical information analysis for an explainable damage assessment, comprising,
a computer memory comprising pre-disaster point cloud imagery data and post-disaster point cloud imagery data in computer memory;
a server communicatively linked via network connections to the computer memory;
a segmentation module configured to receive at least a portion of the pre-disaster point cloud imagery data and a portion of the post-disaster point cloud imagery data;
a damage assessment module configured to receive information from the segmentation module; and
a results module configured to receive information from the damage assessment module to produce explainable results on a human-readable device.

11. The system of claim 10, wherein the plurality of point cloud imagery comprises LiDAR images.

12. The system of claim 10, wherein pre-disaster point cloud imagery data and post-disaster point cloud imagery data comprise point cloud images of a geographic location at two different times.

13. The system of claim 12, wherein the geographic location includes building structures.

14. The system of claim 13, wherein the segmentation module identifies the building structures.

15. The system of claim 10, wherein the damage assessment module uses topological data analysis.

16. The system of claim 10, wherein the damage assessment module uses persistent homology to encode topological features of pre-disaster and post-disaster of the plurality of point cloud imagery data.

17. A method for geometrical information analysis for an explainable damage assessment, comprising,
storing in computer memory pre-disaster point cloud imagery data and post-disaster point cloud imagery data;
connecting a server via network connections to the computer memory;
segmenting features in at least a portion of the pre-disaster point cloud imagery data and a portion of the post-disaster point cloud imagery data; and
assessing differences between the pre-disaster point cloud imagery data and a portion of the post-disaster point cloud imagery data for the same geographical location;
reporting the differences to a human-readable device.

18. The method of claim 17, wherein the plurality of point cloud imagery comprises LiDAR images.

19. The method of claim 17, wherein the features include building structures.

20. The method of claim 17, wherein the assessing step includes the use of topological data analysis.
